(19) United States
(12) Patent Application Publication
(10) Pub. No.: US 2026/0242679 A1
(43) Pub. Date: Aug. 20, 2026

(54) STAGED PYROLYSIS-CATALYTIC GASIFICATION PROCESS SYSTEMS FOR HYDROGEN PRODUCTION FROM BIOMASS WASTE

(71) Applicant: CHANGZHOU UNIVERSITY, Changzhou (CN)

(72) Inventors: Peng LIU, Changzhou (CN); Tiantian LIU, Changzhou (CN); Tingzhou LEI, Changzhou (CN); Tanglei SUN, Changzhou (CN); Yanling LI, Changzhou (CN); Yantao YANG, Changzhou (CN); Suxia REN, Changzhou (CN); Lili DONG, Changzhou (CN); Xueqin LI, Changzhou (CN); Shuhua YANG, Changzhou (CN); Zaifeng LI, Changzhou (CN)

(73) Assignee: CHANGZHOU UNIVERSITY, Changzhou (CN)

(21) Appl. No.: 19/448,043

(22) Filed: Jan. 13, 2026

Related U.S. Application Data
(63) Continuation-in-part of application No. PCT/CN2025/088936, filed on Apr. 15, 2025.

(30) Foreign Application Priority Data
Feb. 19, 2025 (CN) 202510183127.X

(51) Int. Cl. C10J 3/66; B01J 23/755; B01J 29/46; B01J 35/32; B01J 37/02; B01J 37/04; B01J 37/08; B01J 37/34; C01B 3/26; C01B 32/306; C01B 32/324; C01B 32/336; C01B 32/348; C10B 49/06; C10B 53/02; C10B 57/10; C10B 57/16; C10J 3/50; C10J 3/84

(52) U.S. Cl. CPC C10J 3/66; B01J 23/755; B01J 29/46; B01J 35/32; B01J 37/0201; B01J 37/04; B01J 37/088; B01J 37/343; C01B 3/26; C01B 32/306; C01B 32/324; C01B 32/336; C01B 32/348; C10B 49/06; C10B 53/02; C10B 57/10; C10B 57/16; C10J 3/506; C10J 3/84; C01B 2203/0277; C01B 2203/1058; C01B 2203/1082; C01B 2203/1235; C10J 2300/0906; C10J 2300/0909; C10J 2300/092; C10J 2300/0959; C10J 2300/0976; C10J 2300/1603

(57) ABSTRACT

A staged pyrolysis-catalytic gasification process for hydrogen production from biomass waste is provided, including: drying and crushing the biomass waste to obtain crushed biomass waste; continuously adding the crushed biomass waste as feed material into a cascading pyrolysis device to obtain semi-coke and volatile matter, periodically discharging the semi-coke from a bottom of the cascading pyrolysis device, and filtering the volatile matter through the semi-coke accumulated in a catalytic conversion section to remove fly ash to obtain high temperature pyrolysis gas; continuously introducing the high temperature pyrolysis gas into a first atmospheric catalytic converter to cause that tar in the high temperature pyrolysis gas undergoes catalytic cracking to obtain hydrogen-rich fuel gas; and continuously introducing the hydrogen-rich fuel gas into a second atmospheric catalytic converter to cause that alkane gas in the hydrogen-rich fuel gas undergoes catalytic cracking to produce hydrogen.

### CROSS-REFERENCE TO RELATED APPLICATIONS

This application is a continuation-in-part application of International Application No. PCT/CN2025/088936, filed on Apr. 15, 2025, which claims priority to Chinese Patent Application No. 202510183127.X, filed on Feb. 19, 2025, the entire contents of each of which are hereby incorporated by reference.

### TECHNICAL FIELD

The present disclosure generally relates to a field of biomass gasification for hydrogen production, and in particular to, a staged pyrolysis-catalytic gasification process system for hydrogen production from biomass waste.

### BACKGROUND

In recent years, hydrogen energy has attracted much attention as a clean energy carrier. Large-scale preparation technologies for hydrogen energy are mainly concentrated on paths such as fossil fuel cracking and reforming, water electrolysis, and industrial by-product gas purification. Currently, about 96% of global hydrogen production capacity comes from gray hydrogen (obtained from direct cracking of fossil fuels) and blue hydrogen (obtained from fossil reforming coupled with carbon capture). However, production of 1 kg of hydrogen is accompanied by emission of more than 10 kg of CO₂, which significantly contradicts low-carbon development goals. Although green hydrogen production by water electrolysis can achieve zero carbon emissions, the green hydrogen production accounts for only 4% of the total hydrogen production. The green hydrogen production is constrained by problems such as high cost of precious metal catalysts, efficiency bottlenecks of electrolyzers, and volatility of renewable energy power, and it is difficult to achieve large-scale application quickly.

A hydrogen production technology by biomass gasification shows unique advantages due to renewable nature of raw materials and carbon cycle characteristics. The hydrogen production technology by biomass gasification can theoretically achieve full life cycle carbon balance by gasifying and converting biomass resources such as agricultural and forestry waste. If integrated with Carbon Capture, Utilization, and Storage (CCUS) technology, a negative carbon effect can be formed, significantly improving green carbon sink capacity. However, technology faces the following core bottlenecks.

### Hydrogen-Carbon Ratio Imbalance and Selectivity Defects

Biomass raw materials inherently have low hydrogen content (e.g., a typical H/C atomic ratio is 0.1-0.3). In a pyrolysis stage, the hydrogen element preferentially participates in water removal and generation of oxygen-containing volatile matter (e.g., CO and CH₄), resulting in insufficient hydrogen selectivity in gasification products. Experiments show that a hydrogen yield of conventional fluidized bed gasification is generally lower than 60 g/kg biomass, and a H₂ volume concentration in syngas is mostly lower than 40%, which is difficult to meet requirements for efficient hydrogen production.

System Efficiency Restricted by Tar by-Products

A gasification process is accompanied by generation of a large amount of polycyclic aromatic hydrocarbon tar (e.g., a content of the polycyclic aromatic hydrocarbon tar can reach 20 g/Nm³ to 100 g/Nm³). The generation not only causes energy loss (e.g. the energy loss accounts for 15%-30% of raw material energy), but also easily blocks pipelines and poisons catalysts. Existing purification technologies (e.g., cyclone dust removal and catalytic cracking) have problems such as high energy consumption and easy deactivation of the catalysts, which significantly increase system operating costs.

### Process Coupling and Energy Optimization Problem

Biomass gasification requires coordination of multiple reaction stages such as pyrolysis, reforming, and water-gas shift. However, traditional fixed bed and fluidized bed processes have insufficient control capabilities for temperature fields and gas-solid residence times, resulting in low gasification efficiency (e.g., the cold gas efficiency is usually lower than 70%). At the same time, tar treatment and waste heat recovery systems lack integrated optimization, further restricting improvement of overall energy efficiency.

Existing improvement solutions mostly focus on catalyst modification (e.g., doping rare earth elements in nickel-based catalysts) or reactor structure optimization (e.g., dual-bed gasification). Although the existing improvement solutions can improve local reaction efficiency, the existing improvement solutions do not fundamentally solve systemic problems of low hydrogen selectivity and synergistic control of the tar. Therefore, there is an urgent need to develop new gasification processes and reaction systems to achieve dual breakthroughs in biomass hydrogen production efficiency and economy by regulating gasification media, strengthening in-situ catalysis, and optimizing heat and mass transfer.

### SUMMARY

One or more embodiments of the present disclosure provide a staged pyrolysis-catalytic gasification process system for hydrogen production from biomass waste. The process system includes the following steps: (1) drying the biomass waste, and crushing the biomass waste to obtain crushed biomass waste with a particle size of not greater than 3 mm; (2) continuously adding the crushed biomass waste obtained in step (1) as feed material into a cascading pyrolysis device, processing the feed material through a roasting section, a thermal premixing section, a pyrolysis gasification section, and a catalytic reforming section sequentially under an action of gravity to obtain semi-coke and volatile matter, periodically discharging the semi-coke from a bottom of the cascading pyrolysis device, and filtering the volatile matter through the semi-coke accumulated in a catalytic conversion section to remove fly ash to obtain high temperature pyrolysis gas; (3) continuously introducing the high temperature pyrolysis gas into a first atmospheric catalytic converter, to cause that tar in the high temperature pyrolysis gas undergoes catalytic cracking to obtain hydrogen-rich fuel gas; and (4) continuously introducing the hydrogen-rich fuel gas obtained in the first atmospheric catalytic converter into a second atmospheric catalytic converter, to cause that alkane gas in the hydrogen-rich fuel gas undergoes catalytic cracking to produce hydrogen, and hydrogen-enriched fuel gas is produced at a bottom of the second atmospheric catalytic converter.

In some embodiments, the crushed biomass waste obtained in step (1) is added into the cascading pyrolysis device through a screw feeder, and a feeding rate is within a range of 0.5 kg/h to 5 kg/h.

In some embodiments, temperature ranges of the roasting section, the thermal premixing section, the pyrolysis gasification section, and the catalytic reforming section in step (2) are 250° C. to 300° C., 500° C. to 600° C., 750° C. to 800° C., and 900° C. to 1000° C., respectively.

In some embodiments, a mixed gas of pure oxygen and steam is continuously introduced into the catalytic reforming section; a gas inlet of the catalytic reforming section is located at a middle part of the catalytic reforming section; a gas inlet direction of the mixed gas is parallel to ground; a flow rate of the pure oxygen is within a range of 100 mL/min to 200 mL/min; and a flow rate of the steam is within a range of 0.5 g/min to 2 g/min.

In some embodiments, semi-coke discharge is started when a height of the semi-coke in the cascading pyrolysis device exceeds an edge position below a gas inlet of the catalytic reforming section; and the semi-coke discharge is stopped when the height of the semi-coke in the cascading pyrolysis device is below a middle position of the catalytic reforming section.

In some embodiments, a catalyst loaded in the first atmospheric catalytic converter is a nickel-iron based catalyst using a mixture of Hydrogen Zeolite Socony Mobil-5 (HZSM-5) molecular sieve and aluminum smelting waste residue as a support.

In some embodiments, the nickel-iron based catalyst is prepared by a process including: (1) subjecting the aluminum smelting waste residue to acidification pretreatment and high-temperature calcination to obtain porous aluminum smelting waste residue; (2) uniformly mixing the porous aluminum smelting waste residue and the HZSM-5 molecular sieve at a mass ratio of (0-7):(3-10) to obtain a composite support; and (3) adding the composite support to deionized water to obtain an aqueous solution, wherein a mass ratio of the composite support to the deionized water is (1-10):100; then adding nickel nitrate and ferric chloride to the aqueous solution, performing ultrasonic treatment and stirring at 60° C. to 80° C. until water is completely evaporated to obtain a solid mixture; and then placing the solid mixture at 500° C. to 600° C. and calcining in air for 1.5 h to 2 h to obtain the nickel-iron based catalyst, wherein a mass ratio of the nickel nitrate, the ferric chloride, and the composite support is 8:4:100.

In some embodiments, the nickel-iron based catalyst is prepared by a process including: (1) subjecting the aluminum smelting waste residue to acidification pretreatment and high-temperature calcination to obtain porous aluminum smelting waste residue; (2) uniformly mixing the porous aluminum smelting waste residue and the HZSM-5 molecular sieve at a mass ratio of 4:6 to obtain a composite support; and (3) adding the composite support to deionized water to obtain an aqueous solution, wherein a mass ratio of the composite support to the deionized water is (1-10):100; then adding nickel nitrate and ferric chloride to the aqueous solution, performing ultrasonic treatment and stirring at 60° C. to 80° C. until water is completely evaporated to obtain a solid mixture; and then placing the solid mixture at 500° C. to 600° C. and calcining in air for 1.5 h to 2 h to obtain the nickel-iron based catalyst, wherein a mass ratio of the nickel nitrate, the ferric chloride, and the composite support is 8:4:100.

In some embodiments, a packed bulk density of a catalyst in the first atmospheric catalytic conversion reactor is within a range of 0.8 g/cm³ to 1.2 g/cm³.

In some embodiments, a catalyst loaded in the second atmospheric catalytic converter is a nickel-based catalyst using a carbon molecular sieve as a support.

In some embodiments, the nickel-based catalyst is prepared by a process including: (1) uniformly mixing biochar and KOH at a mass ratio of 1:(0.5-4), performing chemical activation at 500° C. to 600° C. for 1 h to 2 h under nitrogen protection, then heating to 800° C. to 1000° C., and performing physical activation for 2 h to 4 h by introducing CO₂ while maintaining introduction of the nitrogen to obtain activated carbon; (2) introducing toluene vapor into the activated carbon at a flow rate of 0.2 g/min to 1.5 g/min through a benzene deposition manner, and reacting at 600° C. to 900° C. for 0.5 h to 1.5 h to perform pore-filling carbonization and deposition on macropores of the activated carbon, to form a hierarchical pore carbon molecular sieve; and (3) adding the hierarchical porous carbon molecular sieve into deionized water, wherein a mass ratio of the hierarchical porous carbon molecular sieve to the deionized water is (1-2): 10; then adding nickel nitrate, performing ultrasonic treatment and stirring at 60° C. to 80° C. until water is completely evaporated; then calcining at 500° C. to 600° C. for 1.5 h to 2.0 h under protection of nitrogen or inert gas to obtain the nickel-based catalyst.

In some embodiments, the nickel-based catalyst is prepared by a process including: (1) uniformly mixing biochar and KOH at a mass ratio of 1:2, performing chemical activation at 500° C. to 600° C. for 1 h to 2 h under nitrogen protection, then heating to 900° C., and performing physical activation for 2 h to 4 h by introducing CO₂ while maintaining introduction of the nitrogen to obtain activated carbon, wherein a flow rate of CO₂ is 50 mL/min; (2) performing pore-filling carbonization and deposition on macropores of the activated carbon through a benzene deposition manner to form a hierarchical pore carbon molecular sieve; and (3) adding the hierarchical porous carbon molecular sieve into deionized water, wherein a mass ratio of the hierarchical porous carbon molecular sieve to the deionized water is (1-2): 10; then adding nickel nitrate, performing ultrasonic treatment and stirring at 60° C. to 80° C. until water is completely evaporated; then calcining at 500° C. to 600° C. for 1.5 h to 2.0 h under protection of nitrogen or inert gas to obtain the nickel-based catalyst.

In some embodiments, the biomass waste includes at least one of pine sawdust, corn stalk, and poplar wood.

### BRIEF DESCRIPTION OF THE DRAWINGS

FIG. 1 is a flowchart of a staged pyrolysis-catalytic gasification process for hydrogen production from biomass waste according to some embodiments of the present disclosure.

FIG. 2 is a schematic structural diagram of a staged pyrolysis-catalytic gasification process system for hydrogen production from the biomass waste according to some embodiments of the present disclosure.

In the figure, 101 refers to a roasting section, 102 refers to a thermal premixing section, 103 refers to a pyrolysis gasification section, 104 refers to a catalytic reforming section, 105 refers to a gas inlet, 200 refers to the staged pyrolysis-catalytic gasification process system for hydrogen production from biomass waste, 210 refers to a cascading pyrolysis device, 220 refers to a first atmospheric catalytic converter, and 230 refers to a second atmospheric catalytic converter.

### DETAILED DESCRIPTION

The present disclosure is described in detail below in conjunction with embodiments. It should be understood that the following embodiments are merely illustrative of implementations of the present disclosure, and do not limit the scope of the present disclosure.

Existing biomass gasification technologies for hydrogen production have a low hydrogen yield, and it is difficult to achieve a yield above 700 mL/g. Embodiments of the present disclosure provide a staged pyrolysis-catalytic gasification process for hydrogen production from biomass waste. Crushed biomass waste is added into a cascading pyrolysis device, the crushed biomass waste is sequentially processed through a roasting section, a thermal premixing section, a pyrolysis gasification section, and a catalytic reforming section to obtain semi-coke and volatile matter, the volatile matter is filtered through the semi-coke to remove fly ash to obtain high temperature pyrolysis gas, the high temperature pyrolysis gas is then sequentially introduced into a first atmospheric catalytic converter and a second atmospheric catalytic converter, and a hydrogen-enriched fuel gas with a hydrogen volume content reaching above 70% can be produced.

Embodiments of the present disclosure provide the staged pyrolysis-catalytic gasification process for hydrogen production from biomass waste. The process includes the following steps: (1) drying the biomass waste and crushing the biomass waste to obtain crushed biomass waste with a particle size of not greater than 3 mm; (2) continuously adding the crushed biomass waste obtained in step (1) as feed material into a cascading pyrolysis device, processing the feed material through the roasting section, the thermal premixing section, the pyrolysis gasification section, and the catalytic reforming section sequentially under an action of gravity to obtain semi-coke and volatile matter, periodically discharging the semi-coke from a bottom of the cascading pyrolysis device, and filtering the volatile matter through the semi-coke accumulated in a catalytic conversion section to remove fly ash to obtain high temperature pyrolysis gas; (3) continuously introducing the high temperature pyrolysis gas into the first atmospheric catalytic converter to cause that tar in the high temperature pyrolysis gas undergoes catalytic cracking to obtain hydrogen-rich fuel gas; and (4) continuously introducing the hydrogen-rich fuel gas obtained in the first atmospheric catalytic converter into the second atmospheric catalytic converter, to cause that alkane gas in the hydrogen-rich fuel gas undergoes catalytic cracking to produce hydrogen, and hydrogen-enriched fuel gas is produced at a bottom of the second atmospheric catalytic converter.

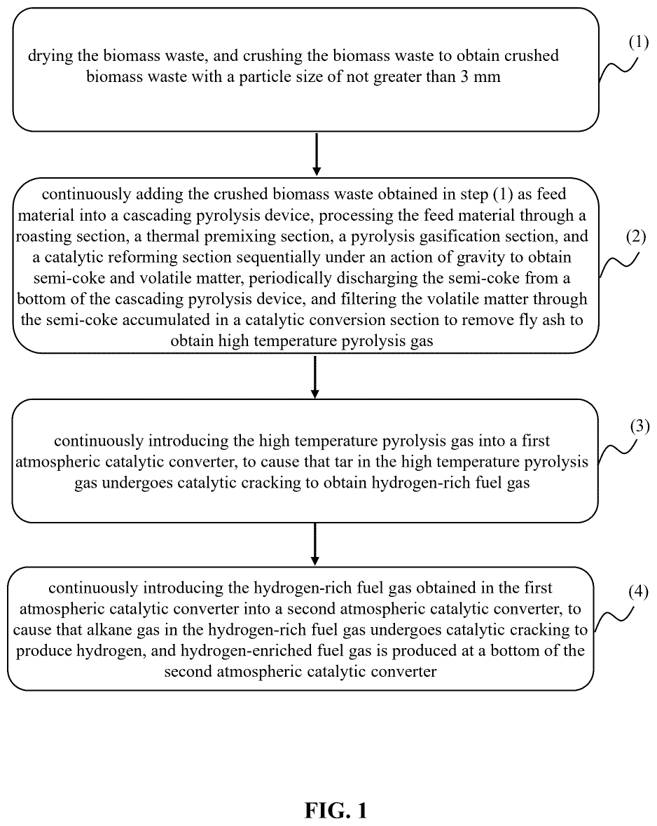

FIG. 1 is a flowchart of a staged pyrolysis-catalytic gasification process for hydrogen production from biomass waste according to some embodiments of the present disclosure.

As shown in FIG. 1, the staged pyrolysis-catalytic gasification process for hydrogen production from biomass waste includes the following steps.

Step (1), drying the biomass waste and crushing the biomass waste to obtain crushed biomass waste with a particle size of not greater than 3 mm.

The biomass waste refers to discarded or considered waste material among renewable organic substances derived from living organisms. For example, the biomass waste includes lignocellulosic agricultural and forestry waste. Merely by way of example, the biomass waste may include at least one of pine sawdust, corn stalk, and poplar wood.

The crushed biomass waste refers to biomass waste that has undergone pretreatment (e.g., drying and crushing).

In some embodiments, a moisture content of the crushed biomass waste is less than 10%.

In some embodiments, the particle size of the crushed biomass waste is not greater than 3 mm. In some embodiments, the particle size of the crushed biomass waste is not greater than 2 mm. In some embodiments, the particle size of the crushed biomass waste is not greater than 1 mm. In some embodiments, the particle size of the crushed biomass waste is 3 mm, 2 mm, 1 mm, etc.

Step (2), continuously adding the crushed biomass waste obtained in the step (1) as feed material into a cascading pyrolysis device, processing the feed material through a roasting section, a thermal premixing section, a pyrolysis gasification section, and a catalytic reforming section sequentially under an action of gravity to obtain semi-coke and volatile matter, periodically discharging the semi-coke from a bottom of the cascading pyrolysis device, and filtering the volatile matter through semi-coke accumulated in a catalytic conversion section to remove fly ash to obtain high temperature pyrolysis gas.

In some embodiments, the crushed biomass waste obtained in the step (1) is added into the cascading pyrolysis device through a screw feeder.

In some embodiments, a feeding rate for adding the crushed biomass waste into the cascading pyrolysis device is within a range of 0.5 kg/h to 5 kg/h. In some embodiments, the feeding rate is 1 kg/h to 5 kg/h. In some embodiments, the feeding rate is 2 kg/h to 5 kg/h. In some embodiments, the feeding rate is 3 kg/h to 4 kg/h. In some embodiments, the feeding rate is 0.5 kg/h, 1 kg/h, 2 kg/h, 3 kg/h, 4 kg/h, 5 kg/h, etc.

The cascading pyrolysis device refers to a multi-stage continuous thermochemical reactor. The cascading pyrolysis device may be configured to process (e.g., roast, pyrolyze, gasify, and catalytically reform) the crushed biomass waste to obtain the semi-coke and the volatile matter (or the high temperature pyrolysis gas).

The cascading pyrolysis device may include the roasting section, the thermal premixing section, the pyrolysis gasification section, and the catalytic reforming section.

The roasting section refers to a section configured to perform thermal deoxygenation and dehydration reactions on the crushed biomass waste. Crushed biomass waste processed through the roasting section may be referred to as a first solid material.

In some embodiments, a temperature range of the roasting section in the step (2) is 250° C. to 300° C. In some embodiments, the temperature range of the roasting section in the step (2) is 260° C. to 300° C. In some embodiments, the temperature range of the roasting section in the step (2) is 270° C. to 300° C. In some embodiments, the temperature range of the roasting section in the step (2) is 280° C. to 300° C. In some embodiments, the temperature range of the roasting section in the step (2) is 290° C. to 300° C. In some embodiments, the temperature of the roasting section in the step (2) is 250° C., 260° C., 270° C., 280° C., 290° C., 300° C., etc.

The thermal premixing section refers to a section configured to preheat the first solid material (e.g., the crushed biomass waste processed through the roasting section) and fully mix the first solid material with rising hot gas (e.g., a mixed gas of pure oxygen and steam). A first solid material processed through the thermal premixing section may be referred to as a second solid material.

In some embodiments, a temperature range of the thermal premixing section in the step (2) is 500° C. to 600° C. In some embodiments, the temperature range of the thermal premixing section in the step (2) is 500° C. to 550° C. In some embodiments, the temperature range of the thermal premixing section in the step (2) is 550° C. to 600° C. In some embodiments, the temperature of the thermal premixing section in the step (2) is 500° C., 520° C., 550° C., 580° C., 600° C., etc.

The pyrolysis gasification section refers to a section configured to perform pyrolysis and preliminary gasification on the second solid material (e.g., crushed biomass waste processed through the roasting section and the thermal premixing section). The second solid material is processed through the pyrolysis gasification section to generate the semi-coke and the volatile matter (e.g., tar and hydrocarbon gases).

In some embodiments, a temperature range of the pyrolysis gasification section in the step (2) is 600° C. to 800° C. In some embodiments, the temperature range of the pyrolysis gasification section in the step (2) is 750° C. to 800° C. In some embodiments, the temperature range of the pyrolysis gasification section in the step (2) is 750° C. to 780° C. In some embodiments, the temperature range of the pyrolysis gasification section in the step (2) is 780° C. to 800° C. In some embodiments, the temperature of the pyrolysis gasification section in the step (2) is 600° C., 700° C., 750° C., 760° C., 780° C., 800° C., etc.

The catalytic reforming section refers to a section configured to perform a catalytic reforming reaction on the tar and the hydrocarbon gases produced in the pyrolysis gasification section. The catalytic reforming section may catalytically reform a portion of the tar and a portion of the hydrocarbon gases to generate the high temperature pyrolysis gas. In some embodiments, the catalytic reforming section may include a catalytic conversion section. A temperature range of the catalytic conversion section is comparable to a temperature range of the catalytic reforming section, and the temperature range of the catalytic conversion section is within a range of 900° C. to 1000° C. The catalytic conversion section may include a section where the semi-coke accumulates.

The catalytic conversion section refers to a section configured to perform a catalytic conversion reaction on the tar and the hydrocarbon gases produced in the pyrolysis gasification section. The catalytic conversion section may catalytically reform a portion of the tar and a portion of the hydrocarbon gases to generate the high temperature pyrolysis gas. There is a coking reaction in the catalytic conversion section, and carbon produced by the coking reaction accumulates in the semi-coke. The high temperature pyrolysis gas may include H₂, CO, CO₂, the hydrocarbon gases (e.g., CH₄), the tar, etc. A temperature of the high temperature pyrolysis gas is comparable to a temperature of the catalytic conversion section, and the temperature of the high temperature pyrolysis gas may be within a range of 900° C. to 1000° C.

In some embodiments, the temperature range of the catalytic reforming section in the step (2) is 900° C. to 1000° C. In some embodiments, the temperature range of the catalytic reforming section in the step (2) is 900° C. to 950° C. In some embodiments, the temperature range of the catalytic reforming section in the step (2) is 950° C. to 1000° C. In some embodiments, a temperature of the catalytic reforming section in the step (2) is 900° C., 920° C., 950° C., 980° C., 1000° C., etc.

In some embodiments, the mixed gas of the pure oxygen and the steam may be continuously introduced into the catalytic reforming section. In the mixed gas, the steam serves as a reactant for the catalytic reforming reaction, and the pure oxygen serves as a reactant for a partial oxidation reaction. A gas inlet of the catalytic reforming section may be located at a middle part of the catalytic reforming section. A gas inlet direction of the mixed gas may be parallel to ground.

The pure oxygen refers to a gas with an oxygen concentration of 90% or more. In some embodiments, a flow rate of the pure oxygen is within a range of 100 mL/min to 200 mL/min. In some embodiments, the flow rate of the pure oxygen is within a range of 120 mL/min to 200 mL/min. In some embodiments, the flow rate of the pure oxygen is within a range of 150 mL/min to 200 mL/min. In some embodiments, the flow rate of the pure oxygen is within a range of 180 mL/min to 200 mL/min. In some embodiments, the flow rate of the pure oxygen is 100 mL/min, 130 mL/min, 150 mL/min, 170 mL/min, 200 mL/min, etc.

In some embodiments, a flow rate of the steam is within a range of 0.5 g/min to 2 g/min. In some embodiments, the flow rate of the steam is within a range of 0.8 g/min to 2 g/min. In some embodiments, the flow rate of the steam is within a range of 1 g/min to 2 g/min. In some embodiments, the flow rate of the steam is within a range of 1.5 g/min to 2 g/min. In some embodiments, the flow rate of the steam is 0.5 g/min, 0.7 g/min, 1 g/min, 1.2 g/min, 1.5 g/min, 1.8 g/min, 2 g/min, etc.

The semi-coke refers to a carbon-rich solid residue obtained after the crushed biomass waste is processed by the cascading pyrolysis device.

The semi-coke may be discharged periodically from the bottom of the cascading pyrolysis device. In some embodiments, semi-coke discharge is started when a height of the semi-coke in the cascading pyrolysis device exceeds an edge position below the gas inlet of the catalytic reforming section; the semi-coke discharge is stopped when the height of the semi-coke in the cascading pyrolysis device is below a middle position of the catalytic reforming section.

The volatile matter refers to a volatile product obtained after the crushed biomass waste is processed by the cascading pyrolysis device. The volatile matter may include H₂, CO, CO₂, the hydrocarbon gases (e.g., CH₄), the tar, etc.

The volatile matter passes through the semi-coke accumulated in the catalytic conversion section, and the fly ash may be removed to obtain the high temperature pyrolysis gas.

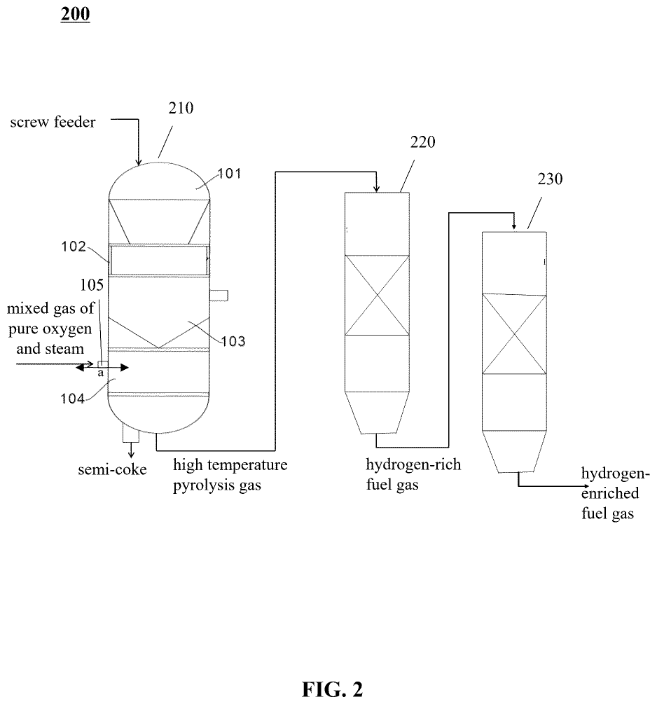

More descriptions regarding the screw feeder, the cascading pyrolysis device, the roasting section, the thermal premixing section, the pyrolysis gasification section, the catalytic reforming section, the gas inlet, the edge position, and the middle part of the catalytic reforming section may be found in FIG. 2 and related descriptions thereof of the present disclosure.

In embodiments of the present disclosure, biomass raw material is added into the cascading pyrolysis device through the screw feeder, and after roasting, a carbon content and a calorific value of the biomass raw material increase. The biomass raw material is processed through the thermal premixing section, the pyrolysis gasification section, and the catalytic reforming section sequentially under the action of gravity. The temperature range of the pyrolysis gasification section is 600° C. to 800° C. The semi-coke obtained from pyrolysis is deposited at the bottom of the cascading pyrolysis device under the action of gravity. As the semi-coke accumulates, the semi-coke may serve as a catalyst for tar conversion to convert a portion of the tar. O₂/H₂O (the mixed gas of the pure oxygen and the steam) is introduced into the catalytic reforming section to catalytically reform the tar and the hydrocarbon gases, and heat is released to achieve self-supplied heating, and the fly ash from the pyrolysis is removed.

Step (3), continuously introducing the high temperature pyrolysis gas into a first atmospheric catalytic converter, to cause that the tar in the high temperature pyrolysis gas undergoes catalytic cracking to obtain hydrogen-rich fuel gas.

The hydrogen-rich fuel gas refers to a fuel gas with a hydrogen volume content within a range of 50%-70%.

The first atmospheric catalytic converter refers to a reactor for cracking the tar in the high temperature pyrolysis gas to obtain the hydrogen-rich fuel gas. The first atmospheric catalytic converter may include an atmospheric fixed-bed reactor.

In some embodiments, a reaction temperature in the first atmospheric catalytic converter is 1000° C.

In some embodiments, a catalyst loaded in the first atmospheric catalytic converter is a nickel-iron based catalyst using a mixture of Hydrogen Zeolite Socony Mobil-5 (HZSM-5) molecular sieve and aluminum smelting waste residue as a support.

In some embodiments, a packed bulk density of the catalyst in the first atmospheric catalytic converter is within a range of 0.8 g/cm³-1.2 g/cm³. In some embodiments, the packed bulk density of the catalyst in the first atmospheric catalytic converter is within a range of 0.9 g/cm³-1.2 g/cm³. In some embodiments, the packed bulk density of the catalyst in the first atmospheric catalytic converter is within a range of 1.0 g/cm³-1.2 g/cm³. In some embodiments, the packed bulk density of the catalyst in the first atmospheric catalytic converter is 0.8 g/cm³, 0.9 g/cm³, 1.0 g/cm³, 1.1 g/cm³, 1.2 g/cm³, etc.

In some embodiments, the nickel-iron based catalyst is prepared by a process. The process includes: (1) subjecting the aluminum smelting waste residue to acidification pretreatment and high-temperature calcination to obtain porous aluminum smelting waste residue; (2) uniformly mixing the porous aluminum smelting waste residue and the HZSM-5 molecular sieve at a mass ratio of (0-7):(3-10) to obtain a composite support; and (3) adding the composite support to deionized water to obtain an aqueous solution, wherein a mass ratio of the composite support to the deionized water is (1-10):100, then adding nickel nitrate and ferric chloride to the aqueous solution, performing ultrasonic treatment and stirring at 60° C. to 80° C. until water is completely evaporated to obtain a solid mixture, and then placing the solid mixture at 500° C. to 600° C. and calcining the solid mixture in air for 1.5 h to 2 h to obtain the nickel-iron based catalyst. A mass ratio of the nickel nitrate, the ferric chloride, and the composite support is 8:4:100.

In some embodiments, an acid for performing the acidification pretreatment on the aluminum smelting waste residue may include dilute sulfuric acid. In some embodiments, a mass concentration of the dilute sulfuric acid may be 30 wt %. In some embodiments, a time for the acidification pretreatment is 4 h.

In some embodiments, a temperature for the high-temperature calcination may be 550° C. to 650° C. In some embodiments, a time for the high-temperature calcination may be 2 h to 5 h.

The porous aluminum smelting waste residue refers to aluminum smelting waste residue with a porous structure obtained from aluminum smelting waste residue that has undergone the acidification pretreatment and the high-temperature calcination.

The composite support refers to a material obtained by uniformly mixing the porous aluminum smelting waste residue and the HZSM-5 molecular sieve at the mass ratio of (0-7):(3-10).

In some embodiments, the mass ratio of the porous aluminum smelting waste residue to the HZSM-5 molecular sieve in the composite support is (0-7):(3-10). In some embodiments, the mass ratio of the porous aluminum smelting waste residue to the HZSM-5 molecular sieve in the composite support is (1-7):(3-10). In some embodiments, the mass ratio of the porous aluminum smelting waste residue to the HZSM-5 molecular sieve in the composite support is (3-7):(3-10). In some embodiments, the mass ratio of the porous aluminum smelting waste residue to the HZSM-5 molecular sieve in the composite support is (5-7):(3-10). In some embodiments, the mass ratio of the porous aluminum smelting waste residue to the HZSM-5 molecular sieve in the composite support is (0-7):(4-9). In some embodiments, the mass ratio of the porous aluminum smelting waste residue to the HZSM-5 molecular sieve in the composite support is (0-7):(5-8). In some embodiments, the mass ratio of the porous aluminum smelting waste residue to the HZSM-5 molecular sieve in the composite support is (0-7):(6-7). In some embodiments, the mass ratio of the porous aluminum smelting waste residue to the HZSM-5 molecular sieve in the composite support is 4:6, etc.

In some embodiments, the mass ratio of the composite support to the deionized water is (1-8):100. In some embodiments, the mass ratio of the composite support to the deionized water is (1-6):100. In some embodiments, the mass ratio of the composite support to the deionized water is (1-4):100. In some embodiments, the mass ratio of the composite support to the deionized water is (1-2):100. In some embodiments, the mass ratio of the composite support to the deionized water is 1:100, 2:100, 5:100, 7:100, 8:100, 1:10, etc.

In some embodiments, in the preparation of the nickel-iron based catalyst, a temperature for performing the ultrasonic treatment and the stirring is 60° C. to 80° C. In some embodiments, in the preparation of the nickel-iron based catalyst, the temperature for performing the ultrasonic treatment and the stirring is 65° C. to 80° C. In some embodiments, in the preparation of the nickel-iron based catalyst, the temperature for performing the ultrasonic treatment and the stirring is 70° C. to 80° C. In some embodiments, in the preparation of the nickel-iron based catalyst, the temperature for performing the ultrasonic treatment and the stirring is 75° C. to 80° C. In some embodiments, in the preparation of the nickel-iron based catalyst, the temperature for performing the ultrasonic treatment and the stirring is 60° C., 70° C., 80° C., etc.

In some embodiments, a calcination temperature for the solid mixture is 500° C. to 600° C. In some embodiments, the calcination temperature for the solid mixture is 530° C. to 600° C. In some embodiments, the calcination temperature for the solid mixture is 550° C. to 600° C. In some embodiments, the calcination temperature for the solid mixture is 580° C. to 600° C. In some embodiments, the calcination temperature for the solid mixture is 500° C., 520° C., 550° C., 580° C., 600° C., etc.

In some embodiments, a calcination time for the solid mixture is 1.5 h to 2 h. In some embodiments, the calcination time for the solid mixture is 1.8 h to 2 h. In some embodiments, the calcination time for the solid mixture is 1.5 h, 1.7 h, 2 h, etc.

In embodiments of the present disclosure, in the cascading pyrolysis device for the biomass waste (e.g., wood waste), 30%-50% of the tar can be converted, but 50%-70% of the tar remains unconverted. The high temperature pyrolysis gas containing the tar is introduced into the first atmospheric catalytic converter. The catalyst loaded in the first atmospheric catalytic converter is the nickel-iron based catalyst using the mixture of the HZSM-5 molecular sieve and the aluminum smelting waste residue as the support. The nickel-iron based catalyst enables further catalytic conversion of the tar to obtain the hydrogen-rich fuel gas at a conversion temperature of 800° C.-1000° C., and a tar conversion rate can reach over 99%.

Step (4), continuously introducing the hydrogen-rich fuel gas obtained in the first atmospheric catalytic converter into a second atmospheric catalytic converter, to cause that alkane gas in the hydrogen-rich fuel gas undergoes catalytic cracking to produce hydrogen, and hydrogen-enriched fuel gas is produced at a bottom of the second atmospheric catalytic converter.

The second atmospheric catalytic converter refers to a reactor for catalytically cracking the alkane gas in the hydrogen-rich fuel gas to obtain the hydrogen-enriched fuel gas. The second atmospheric catalytic converter may include an atmospheric fixed-bed reactor.

The hydrogen-enriched fuel gas refers to fuel gas having a hydrogen volume content of 70% or more. In some embodiments, the hydrogen volume content in the hydrogen-enriched fuel gas reaches 75% or more. In some embodiments, the hydrogen volume content in the hydrogen-enriched fuel gas reaches 80% or more. In some embodiments, the hydrogen volume content in the hydrogen-enriched fuel gas reaches 85% or more. In some embodiments, the hydrogen volume content in the hydrogen-enriched fuel gas reaches 90% or more. In some embodiments, the hydrogen volume content in the hydrogen-enriched fuel gas reaches 95% or more.

In some embodiments, a reaction temperature in the second atmospheric catalytic converter is 800° C.

In some embodiments, a catalyst loaded in the second atmospheric catalytic converter is a nickel-based catalyst using a carbon molecular sieve as a support.

In some embodiments, the nickel-based catalyst is prepared by a process. The process includes: (1) uniformly mixing biochar and KOH at a mass ratio of 1:(0.5-4), performing chemical activation at 500° C. to 600° C. for 1 h to 2 h under nitrogen protection, then heating to 800° C. to 1000° C., and performing physical activation for 2 h to 4 h by introducing CO₂ while maintaining introduction of the nitrogen to obtain activated carbon; (2) introducing toluene vapor into the activated carbon at a flow rate of 0.2 g/min to 1.5 g/min though a benzene deposition manner, and reacting at 600° C. to 900° C. for 0.5 h to 1.5 h to perform pore-filling carbonization and deposition on macropores of the activated carbon, to form a hierarchical pore carbon molecular sieve; and (3) adding the hierarchical pore carbon molecular sieve into deionized water, wherein a mass ratio of the hierarchical pore carbon molecular sieve to the deionized water is (1-2):10, then calculating a dosage of nickel nitrate based on a mass ratio range of metallic nickel to the hierarchical pore carbon molecular sieve in the nickel-based catalyst being 4%-8%, adding the nickel nitrate, performing ultrasonic treatment and stirring at 60° C.-80° C. until water is completely evaporated, and then calcining at 500° C.-600° C. for 1.5 h-2.0 h under protection of nitrogen or inert gas to obtain the nickel-based catalyst.

The biochar may be obtained by pyrolyzing (e.g., pyrolyzing at 800° C. for 0.5 h) the biomass waste (e.g., the pine sawdust) under protection of nitrogen or inert gas.

In some embodiments, the mass ratio of the biochar to KOH is 1:(0.5-4). In some embodiments, the mass ratio of the biochar to KOH is 1:(1-4). In some embodiments, the mass ratio of the biochar to KOH is 1:(2-4). In some embodiments, the mass ratio of the biochar to KOH is 1:(3-4). In some embodiments, the mass ratio of the biochar to KOH is 1:1, 1:2, 1:3, 1:4, etc.

In some embodiments, a temperature of the chemical activation is 500° C. to 600° C. In some embodiments, the temperature of the chemical activation is 500° C. to 550° C. In some embodiments, the temperature of the chemical activation is 550° C. to 600° C. In some embodiments, the temperature of the chemical activation is 500° C., 550° C., 600° C., etc.

In some embodiments, a time of the chemical activation is 1 h to 2 h. In some embodiments, the time of the chemical activation is 1.2 h to 2 h. In some embodiments, the time of the chemical activation is 1.5 h to 2 h. In some embodiments, the time of the chemical activation is 1.8 h to 2 h. In some embodiments, the time of the chemical activation is 1 h, 1.5 h, 2 h, etc.

In some embodiments, a temperature of the physical activation is 800° C. to 1000° C. In some embodiments, the temperature of the physical activation is 850° C. to 1000° C. In some embodiments, the temperature of the physical activation is 900° C. to 1000° C. In some embodiments, the temperature of the physical activation is 950° C. to 1000° C. In some embodiments, the temperature of the physical activation is 800° C., 900° C., 1000° C., etc.

In some embodiments, a time of the physical activation is 2 h to 4 h. In some embodiments, the time of the physical activation is 2 h to 3 h. In some embodiments, the time of the physical activation is 3 h to 4 h. In some embodiments, the time of the physical activation is 2 h, 3 h, 4 h, etc.

In some embodiments, a flow rate of CO₂ introduced during the physical activation is 50 mL/min.

In some embodiments, a volume flow ratio of CO₂ to the nitrogen during the physical activation is 1:1.

In some embodiments, a flow rate of the toluene vapor is 0.2 g/min to 1.5 g/min. In some embodiments, the flow rate of the toluene vapor is 0.5 g/min to 1.5 g/min. In some embodiments, the flow rate of the toluene vapor is 1.2 g/min to 1.5 g/min. In some embodiments, the flow rate of the toluene vapor is 0.2 g/min, 0.5 g/min, 0.8 g/min, 1.0 g/min, 1.2 g/min, 1.5 g/min, etc.

In some embodiments, a temperature of the benzene deposition manner is 600° C. to 900° C. In some embodiments, the temperature of the benzene deposition manner is 700° C. to 900° C. In some embodiments, the temperature of the benzene deposition manner is 800° C. to 900° C. In some embodiments, the temperature of the benzene deposition manner is 600° C., 700° C., 800° C., 900° C., etc.

In some embodiments, a time of the benzene deposition manner is 0.5 h to 1.5 h. In some embodiments, the time of the benzene deposition manner is 1 h to 1.5 h. In some embodiments, the time of the benzene deposition manner is 0.5 h, 1 h, 1.5 h, etc.

A mass space velocity of the toluene vapor on the activated carbon refers to a mass of the toluene vapor passing through a unit mass of the activated carbon per a unit time. In some embodiments, in the benzene deposition manner, the mass space velocity of the toluene vapor on the activated carbon is 0.4 h-1 to 18 h-1. In some embodiments, in the benzene deposition manner, the mass space velocity of the toluene vapor on the activated carbon is 0.4 h-1 to 15 h-1. In some embodiments, in the benzene deposition manner, the mass space velocity of the toluene vapor on the activated carbon is 0.4 h-1 to 10 h-1. In some embodiments, in the benzene deposition manner, the mass space velocity of the toluene vapor on the activated carbon is 0.4 h-1 to 5 h-1. In some embodiments, in the benzene deposition manner, the mass space velocity of the toluene vapor on the activated carbon is 0.4 h-1 to 2 h-1. In some embodiments, in the benzene deposition manner, the mass space velocity of the toluene vapor on the activated carbon is 0.4 h-1, 1 h-1, 1.2 h-1, 2 h-1, 10 h-1, 15 h-1, 18 h-1, etc.

The hierarchical pore carbon molecular sieve refers to a carbon molecular sieve having a hierarchical pore structure (e.g., macropores, mesopores, and micropores).

In some embodiments, the mass ratio of the hierarchical pore carbon molecular sieve to the deionized water is (1-2): 10. In some embodiments, the mass ratio of the hierarchical pore carbon molecular sieve to the deionized water is 1:10, 2:10, etc.

In some embodiments, in the preparation of the nickel-based catalyst, a temperature for performing the ultrasonic treatment and the stirring is 60° C. to 80° C. In some embodiments, in the preparation of the nickel-based catalyst, the temperature for performing the ultrasonic treatment and the stirring is 60° C. to 70° C. In some embodiments, in the preparation of the nickel-based catalyst, the temperature for performing the ultrasonic treatment and the stirring is 70° C. to 80° C. In some embodiments, in the preparation of the nickel-based catalyst, the temperature for performing the ultrasonic treatment and the stirring is 60° C., 70° C., 80° C., etc.

In some embodiments, in the preparation of the nickel-based catalyst, a calcination temperature is 500° C. to 600° C. In some embodiments, in the preparation of the nickel-based catalyst, the calcination temperature is 500° C. to 550° C. In some embodiments, in the preparation of the nickel-based catalyst, the calcination temperature is 550° C. to 600° C. In some embodiments, in the preparation of the nickel-based catalyst, the calcination temperature is 500° C., 550° C., 600° C., etc.

In some embodiments, in the preparation of the nickel-based catalyst, a calcination time is 1.5 h to 2.0 h. In some embodiments, in the preparation of the nickel-based catalyst, the calcination time may be 1.5 h, 1.8 h, 2.0 h, etc.

In the embodiments of the present disclosure, the hydrogen-rich fuel gas still contains a certain amount of the hydrocarbon gases such as CH₄, and a proportion of CO₂ is slightly high. The hydrogen-rich fuel gas is introduced into the second atmospheric catalytic converter for catalytic reforming and converting, and finally the hydrogen-enriched fuel gas is obtained. A hydrogen volume content in the hydrogen-enriched fuel gas reaches more than 70%.

In the embodiments of the present disclosure, a graded and stepwise thermochemical conversion is achieved, inexpensive aluminum smelting waste residue, the semi-coke obtained from the pyrolysis, and the carbon molecular sieve are used as catalysts, and tar steam is processed catalytically through pyrolysis residues, thereby significantly reducing a tar yield in the pyrolysis process and increasing a hydrogen yield. The aluminum smelting waste residue coupled with the HZSM-5 molecular sieve catalyzes the tar cracking, improving the effect of the inexpensive nickel-based catalyst on catalytic tar cracking for hydrogen production. Catalytic reforming of the hydrocarbon gases is performed using the carbon molecular sieve loaded with nickel, enabling the hydrogen volume content in the hydrogen-enriched fuel gas to reach more than 70%, which achieves energy recovery and volume reduction of the biomass waste, along with harmless treatment and resource utilization of the aluminum smelting waste residue and the pyrolysis residues.

FIG. 2 is a schematic structural diagram of a staged pyrolysis-catalytic gasification process system for hydrogen production from the biomass waste according to an embodiment of the present disclosure.

As shown in FIG. 2, a staged pyrolysis-catalytic gasification process system 200 for hydrogen production from the biomass waste includes a cascading pyrolysis device 210, a first atmospheric catalytic converter 220, and a second atmospheric catalytic converter 230. The cascading pyrolysis device 210, the first atmospheric catalytic converter 220, and the second atmospheric catalytic converter 230 may be sequentially connected. Merely by way of example, a lower part of the cascading pyrolysis device 210 is connected to an upper part of the first atmospheric catalytic converter 220 through a pipeline, and a lower part of the first atmospheric catalytic converter 220 is connected to an upper part of the second atmospheric catalytic converter 230 through a pipeline.

The cascading pyrolysis device 210 includes a roasting section 101, a thermal premixing section 102, a pyrolysis gasification section 103, and a catalytic reforming section 104. The roasting section 101, the thermal premixing section 102, the pyrolysis gasification section 103, and the catalytic reforming section 104 are connected to each other.

The roasting section 101 is located at a topmost part of the cascading pyrolysis device 210. In the embodiments of the present disclosure, “above,” “up,” and “top” refer to a direction opposite to gravity, and the “upper part” refers to a portion in the direction opposite to gravity.

The thermal premixing section 102 is located below the roasting section 101 and above the pyrolysis gasification section 103.

The pyrolysis gasification section 103 is located below the thermal premixing section 102 and above the catalytic reforming section 104.

The catalytic reforming section 104 is located below the pyrolysis gasification section 103. In some embodiments, the catalytic reforming section 104 may include a catalytic conversion section (not shown in FIG. 2). The catalytic conversion section may include a section in the catalytic reforming section 104 where semi-coke accumulates.

A screw feeder may be located at an upper part of the cascading pyrolysis device 210.

As shown in FIG. 2, a gas inlet 105 is located at a middle part of the catalytic reforming section 104.

A middle part of a catalytic reforming section refers to a position area at an approximately middle height of the catalytic reforming section in a vertical direction. The approximately middle height refers to any position within an area of ±¼ of a height of the catalytic reforming section from a midpoint position of the catalytic reforming section, any position within an area of ±⅕ of the height of the catalytic reforming section from the midpoint position, any position within an area of ±⅙ of the height of the catalytic reforming section from the midpoint position, etc. As another example, the middle part of the catalytic reforming section may include a position area between a position ¼ of the height of the catalytic reforming section 104 upward from the midpoint position of the catalytic reforming section 104 and a position ¼ of the height of the catalytic reforming section 104 downward from the midpoint position.

An edge position below a gas inlet refers to a position of a lowermost edge of the gas inlet. As shown in FIG. 2, the edge position below the gas inlet 105 may be a position indicated by a double arrow “a”. A cascading pyrolysis device used in Example 1 of the present disclosure is a staged pyrolysis-catalytic gasification device for hydrogen production from wood waste in Chinese Patent Application with publication No. CN114907869 A. A roasting section, a thermal premixing section, a pyrolysis gasification section, and a catalytic reforming section in the embodiments of the present disclosure correspond to a roasting section 101, a thermal premixing section 102, a pyrolysis gasification section 103, and a catalytic reforming section 104 in the structure of the staged pyrolysis-catalytic gasification device for hydrogen production from wood waste in the previous patent application of the research team of the present disclosure, respectively.

The first atmospheric catalytic converter and the second atmospheric catalytic converter used in Example 1 of the present disclosure are both atmospheric fixed-bed reactors, purchased from Suzhou Furande Experimental Equipment Co., Ltd. with a model of FD-BC. During reaction, a catalyst was packed in a catalyst packing zone inside the atmospheric fixed-bed reactor, and a packed bulk density was 0.8 g/cm³.

A composition of aluminum smelting waste residue (from Huzhou Senge New Material Co., Ltd.) used in Example 1 of the present disclosure is shown in Table 1.

TABLE 1

| | | | | | | | | | | | Unavoidable |
|---|---|---|---|---|---|---|---|---|---|---|---|
| Composition | Al₂O₃ | MgO | SiO₂ | CaO | Fe₂O₃ | TiO₂ | ZnO | BaO | CuO | Na₂O | impurities |
| wt % | 78.80 | 6.43 | 3.43 | 3.35 | 1.41 | 0.49 | 0.44 | 0.54 | 0.36 | 1.72 | Balance |

A catalyst loaded in the first atmospheric catalytic converter in Example 1 of the present disclosure was a nickel-iron based catalyst using a mixture of HZSM-5 molecular sieve and the aluminum smelting waste residue as a support. A process for preparing the nickel-iron based catalyst included the following steps.

(1) The aluminum smelting waste residue was soaked in dilute sulfuric acid with a mass concentration of 30%, stirred to react for 4 h to perform acidification pretreatment.

(2) The aluminum smelting waste residue after the acidification pretreatment was placed in air at 600° C. for performing calcination for 3 h to obtain porous aluminum smelting waste residue.

(3) The porous aluminum smelting waste residue and the HZSM-5 molecular sieve were uniformly mixed at a mass ratio of 4:6 to obtain a composite support.

(4) The composite support was added to deionized water to obtain an aqueous solution. A mass ratio of the composite support to the deionized water was 1:10. Then nickel nitrate and ferric chloride were added to the aqueous solution, and subjected to ultrasonic treatment and stirred at 60° C. until water was completely evaporated to obtain a solid mixture. Then the solid mixture was placed at 550° C. and calcined in air for 2 h to obtain the nickel-iron based catalyst. A mass ratio of the nickel nitrate, the ferric chloride, and the composite support was 8:4:100.

The HZSM-5 molecular sieve used in the examples of the present disclosure had a model of HZSM-5 and a silicon-aluminum ratio of 25. The HZSM-5 molecular sieve was purchased from Nankai University Catalyst Factory.

A catalyst loaded in the second atmospheric catalytic converter in Example 1 of the present disclosure was a nickel-based catalyst using a carbon molecular sieve as a support. A process for preparing the nickel-based catalyst included the following steps.

(1) Biochar and KOH were uniformly mixed at a mass ratio of 1:2 to obtain a mixture. The mixture was subjected to chemical activation at 550° C. for 2 h under nitrogen protection, then heated to 900° C., and subjected to physical activation for 2 h by introducing CO₂ while introduction of the nitrogen was maintained to obtain activated carbon. A flow rate of the CO₂ was 50 mL/min. A volume flow ratio of the CO₂ to the nitrogen was 1:1.

(2) 75 g of the activated carbon was placed in the atmospheric fixed-bed reactor, and the toluene vapor was introduced at a flow rate of 0.5 g/min through a benzene deposition manner to react at 900° C. for 0.5 h to obtain a hierarchical pore carbon molecular sieve.

(3) The hierarchical pore carbon molecular sieve was added to deionized water. A mass ratio of the hierarchical pore carbon molecular sieve to the deionized water was 1:10. Then nickel nitrate was added, and subjected to ultrasonic treatment and stirred at 60° C. until water was completely evaporated. Then calcination was performed at 550° C. for 2 h under nitrogen protection to obtain the nickel-based catalyst.

The biochar in the process for preparing the nickel-based catalyst was pyrolysis char obtained by pyrolyzing pine sawdust at 800° C. for 0.5 h under nitrogen protection.

A tar yield in the examples of the present disclosure is calculated as: the tar yield=a mass of the tar/a mass of biomass waste×100%.

A hydrogen content unit in the following examples of the present disclosure is expressed as mL/g. The hydrogen content unit of mL/g refers to a volume of hydrogen obtained under a standard condition per gram of biomass after staged pyrolysis-catalytic gasification for hydrogen production.

### Example 1

A staged pyrolysis-catalytic gasification process for hydrogen production from biomass waste (a flowchart of the process shown in FIG. 1) included the following steps.

(1) Pine sawdust was dried until a moisture content was less than 10% and crushed to obtain crushed biomass waste with a particle size of 3 mm.

(2) The crushed biomass waste obtained in step (1) as a feed material was continuously added into a cascading pyrolysis device through a screw feeder. A feeding rate was 5 kg/h. The feed material was processed through a roasting section, a thermal premixing section, a pyrolysis gasification section, and a catalytic reforming section sequentially under actions of gravity and a premixing stirring component inside the cascading pyrolysis device to obtain semi-coke and volatile matter. Temperatures of the roasting section, the thermal premixing section, the pyrolysis gasification section, and the catalytic reforming section were 250° C., 500° C., 750° C., and 900° C., respectively. A mixed gas of pure oxygen and steam was continuously introduced into the catalytic reforming section. A gas inlet was located at a middle part of the catalytic reforming section. A gas inlet direction was parallel to ground. A flow rate of the pure oxygen was 100 mL/min. A flow rate of the steam was 0.5 g/min. Semi-coke discharge was started when a height of the semi-coke in the cascading pyrolysis device exceeded an edge position below the gas inlet of the catalytic reforming section, the semi-coke discharge was stopped when the height of the semi-coke in the cascading pyrolysis device was below a middle position of the catalytic reforming section. The volatile matter was filtered through the semi-coke accumulated in a catalytic conversion section to remove fly ash to obtain high temperature pyrolysis gas. In the high temperature pyrolysis gas, a hydrogen content was 450 mL/g, a methane content was 55 mL/g, a carbon dioxide content was 100 mL/g, a carbon monoxide content was 175 mL/g, and a tar yield was 8%.

(3) The high temperature pyrolysis gas was continuously introduced into the first atmospheric catalytic converter through a pipeline. The tar in the high temperature pyrolysis gas was catalytically cracked in the first atmospheric catalytic converter, a reaction temperature was 1000° C., and hydrogen-rich fuel gas was obtained. In the hydrogen-rich fuel gas, a hydrogen content was 579 mL/g, a methane content was 33 mL/g, a carbon dioxide content was 125 mL/g, a carbon monoxide content was 223 mL/g, and a tar yield was reduced to 0.1%.

(4) The hydrogen-rich fuel gas obtained from the first atmospheric catalytic converter was continuously introduced into a second atmospheric catalytic converter. Alkane gas in the hydrogen-rich fuel gas was catalytically cracked in the second atmospheric catalytic converter to produce hydrogen, a reaction temperature was 800° C., gas was collected from a bottom of the second atmospheric catalytic converter, and hydrogen-enriched fuel gas was obtained. In the hydrogen-enriched fuel gas, a hydrogen content was 725 mL/g, a methane content was 10 mL/g, a carbon dioxide content was 55 mL/g, and a carbon monoxide content was 253 mL/g.

### Example 2

Example 2 differed from Example 1 in that temperatures of the roasting section, the thermal premixing section, the pyrolysis gasification section, and the catalytic reforming section in Example 2 were 200° C., 300° C., 600° C., and 800° C., respectively.

In the high temperature pyrolysis gas obtained in Example 2, a hydrogen content was 320 mL/g, a methane content was 105 mL/g, a carbon dioxide content was 120 mL/g, a carbon monoxide content was 160 mL/g, and a tar yield was 10%.

In the hydrogen-rich fuel gas obtained in Example 2, a hydrogen content was 490 mL/g, a methane content was 65 mL/g, a carbon dioxide content was 135 mL/g, a carbon monoxide content was 180 mL/g, and a tar yield was reduced to 1%.

In the hydrogen-enriched fuel gas obtained in Example 2, a hydrogen content was 579 mL/g, a methane content was 35 mL/g, a carbon dioxide content was 95 mL/g, and a carbon monoxide content was 235 mL/g.

### Example 3

Example 3 differed from Example 1 in that temperatures of the roasting section, the thermal premixing section, the pyrolysis gasification section, and the catalytic reforming section in Example 3 were 300° C., 600° C., 800° C., and 1000° C., respectively.

In the high temperature pyrolysis gas obtained in Example 3, a hydrogen content was 420 mL/g, a methane content was 75 mL/g, a carbon dioxide content was 65 mL/g, a carbon monoxide content was 185 mL/g, and a tar yield was 9%.

In the hydrogen-rich fuel gas obtained in Example 3, a hydrogen content was 510 mL/g, a methane content was 40 mL/g, a carbon dioxide content was 120 mL/g, a carbon monoxide content was 220 mL/g, and a tar yield was reduced to 0.5%.

In the hydrogen-enriched fuel gas obtained in Example 3, a hydrogen content was 710 mL/g, a methane content was 18 mL/g, a carbon dioxide content was 56 mL/g, and a carbon monoxide content was 265 mL/g.

### Example 4

Example 4 differed from Example 1 in that a process for preparing a catalyst used in the first atmospheric catalytic converter of Example 4 included the following steps.

(1) The aluminum smelting waste residue was soaked in dilute sulfuric acid with a mass concentration of 30%, and stirred to react for 4 h to perform acidification pretreatment.

(2) The aluminum smelting waste residue after the acidification pretreatment was placed in air at 600° C., and subjected to calcination for 3 h to obtain porous aluminum smelting waste residue.

(3) The porous aluminum smelting waste residue and the HZSM-5 molecular sieve were uniformly mixed at a mass ratio of 4:6 to obtain a composite support.

(4) The composite support was added to deionized water to obtain an aqueous solution. A mass ratio of the composite support to the deionized water was 1:10. Then nickel nitrate and ferric chloride were added to the aqueous solution, and subjected to ultrasonic treatment and stirred at 60° C. until water was completely evaporated to obtain a solid mixture. Then the solid mixture was placed at 550° C. and calcined in air for 2 h to obtain the nickel-iron based catalyst. A mass ratio of the nickel nitrate, the ferric chloride, and the composite support was 4:1:100.

In the high temperature pyrolysis gas obtained in Example 4, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Example 4, a hydrogen content was 490 mL/g, a methane content was 50 mL/g, a carbon dioxide content was 115 mL/g, a carbon monoxide content was 180 mL/g, and a tar yield was reduced to 0.4%.

In the hydrogen-enriched fuel gas obtained in Example 4, a hydrogen content was 662 mL/g, a methane content was 20 mL/g, a carbon dioxide content was 85 mL/g, and a carbon monoxide content was 260 mL/g.

### Example 5

Example 5 differed from Example 1 in that a process for preparing a catalyst used in the first atmospheric catalytic converter of Example 5 included the following steps.

(1) The aluminum smelting waste residue was soaked in dilute sulfuric acid with a mass concentration of 30%, and stirred to react for 4 h to perform acidification pretreatment.

(2) The aluminum smelting waste residue after the acidification pretreatment was placed in air at 600° C., subjected to calcination for 3 h to obtain porous aluminum smelting waste residue.

(3) The porous aluminum smelting waste residue and the HZSM-5 molecular sieve were uniformly mixed at a mass ratio of 4:6 to obtain a composite support.

(4) The composite support was added to deionized water to obtain an aqueous solution. A mass ratio of the composite support to the deionized water was 1:10. Then nickel nitrate and ferric chloride were added to the aqueous solution, and subjected to ultrasonic treatment and stirred at 60° C. until water was completely evaporated to obtain a solid mixture. Then the solid mixture was placed at 550° C. and calcined in air for 2 h to obtain the nickel-iron based catalyst. A mass ratio of the nickel nitrate, the ferric chloride, and the composite support was 6:2:100.

In the high temperature pyrolysis gas obtained in Example 5, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Example 5, a hydrogen content was 510 mL/g, a methane content was 35 mL/g, a carbon dioxide content was 115 mL/g, a carbon monoxide content was 186 mL/g, and a tar yield was reduced to 0.4%.

In the hydrogen-enriched fuel gas obtained in Example 5, a hydrogen content was 685 mL/g, a methane content was 12 mL/g, a carbon dioxide content was 80 mL/g, and a carbon monoxide content was 255 mL/g.

### Comparative Example 1

Comparative Example 1 differed from Example 1 in that a catalyst loaded in the first atmospheric catalytic converter of Comparative Example 1 was a nickel-iron based catalyst using the HZSM-5 molecular sieve as a support. The process for preparing the nickel-iron based catalyst included the following steps.

The HZSM-5 molecular sieve was added to deionized water to obtain an aqueous solution. A mass ratio of the HZSM-5 molecular sieve to the deionized water was 1:10. Nickel nitrate and ferric chloride were then added to the aqueous solution and subjected to ultrasonic treatment and stirred at 60° C. until water was completely evaporated to obtain a solid mixture. The solid mixture was then calcined in air at 550° C. for 2 h to obtain the nickel-iron based catalyst. A mass ratio of the nickel nitrate, the ferric chloride, and the HZSM-5 molecular sieve was 8:4:100.

In the high temperature pyrolysis gas obtained in Comparative Example 1, a hydrogen content was 450 mL/g, a methane content was 55 mL/g, a carbon dioxide content was 100 mL/g, and a carbon monoxide content was 175 mL/g.

In the hydrogen-rich fuel gas obtained in Comparative Example 1, a hydrogen content was 520 mL/g, a methane content was 45 mL/g, a carbon dioxide content was 125 mL/g, a carbon monoxide content was 196 mL/g, and a tar yield was 0.4%.

In the hydrogen-enriched fuel gas obtained in Comparative Example 1, a hydrogen content was 679 mL/g, a methane content was 15 mL/g, a carbon dioxide content was 75 mL/g, and a carbon monoxide content was 265 mL/g.

### Comparative Example 2

Comparative Example 2 differed from Example 1 in that a catalyst loaded in the first atmospheric catalytic converter of Comparative Example 2 was a nickel-iron based catalyst using aluminum smelting waste residue as a support. The process for preparing the nickel-iron based catalyst included the following steps.

(1) The aluminum smelting waste residue was soaked in dilute sulfuric acid with a mass concentration of 30%, and stirred to react for 4 h to perform acidification pretreatment.

(2) The aluminum smelting waste residue after the acidification pretreatment was calcined in air at 600° C. for 3 h to obtain porous aluminum smelting waste residue.

(3) The porous aluminum smelting waste residue was added to deionized water to obtain an aqueous solution. A mass ratio of the porous aluminum smelting waste residue to the deionized water was 1:10. Nickel nitrate and ferric chloride were then added to the aqueous solution and subjected to ultrasonic treatment and stirred at 60° C. until water was completely evaporated to obtain a solid mixture. The solid mixture was then calcined in air at 550° C. for 2 h to obtain the nickel-iron based catalyst. A mass ratio of the nickel nitrate, the ferric chloride, and the porous aluminum smelting waste residue was 8:4:100.

In the high temperature pyrolysis gas obtained in Comparative Example 2, a hydrogen content was 450 mL/g, a methane content was 55 mL/g, a carbon dioxide content was 100 mL/g, a carbon monoxide content was 175 mL/g.

In the hydrogen-rich fuel gas obtained in Comparative Example 2, a hydrogen content was 500 mL/g, a methane content was 50 mL/g, a carbon dioxide content was 145 mL/g, a carbon monoxide content was 210 mL/g, and a tar yield was 1%.

In the hydrogen-enriched fuel gas obtained in Comparative Example 2, a hydrogen content was 628 mL/g, a methane content was 25 mL/g, a carbon dioxide content was 120 mL/g, and a carbon monoxide content was 290 mL/g.

### Comparative Example 3

Comparative Example 3 differed from Example 1 in that when preparing the nickel-iron based catalyst using a mixture of the HZSM-5 molecular sieve and the aluminum smelting waste residue as a support, step (3) included uniformly mixing the porous aluminum smelting waste residue and the HZSM-5 molecular sieve at a mass ratio of 7:3 to obtain a composite support in Comparative Example 3.

In the high temperature pyrolysis gas obtained in Comparative Example 3, a hydrogen content was 450 mL/g, a methane content was 55 mL/g, a carbon dioxide content was 100 mL/g, a carbon monoxide content was 175 mL/g.

In the hydrogen-rich fuel gas obtained in Comparative Example 3, a hydrogen content was 510 mL/g, a methane content was 45 mL/g, a carbon dioxide content was 135 mL/g, a carbon monoxide content was 200 mL/g, and a tar yield was 0.6%.

In the hydrogen-enriched fuel gas obtained in Comparative Example 3, a hydrogen content was 682 mL/g, a methane content was 20 mL/g, a carbon dioxide content was 115 mL/g, and a carbon monoxide content was 265 mL/g.

### Comparative Example 4

Comparative Example 4 differed from Example 1 in that when preparing a nickel-iron based catalyst using a mixture of the HZSM-5 molecular sieve and the aluminum smelting waste residue as a support, step (3) included uniformly mixing the porous aluminum smelting waste residue and the HZSM-5 molecular sieve at a mass ratio of 1:9 to obtain a composite support in Comparative Example 4.

In the high temperature pyrolysis gas obtained in Comparative Example 4, a hydrogen content was 450 mL/g, a methane content was 55 mL/g, a carbon dioxide content was 100 mL/g, and a carbon monoxide content was 175 mL/g.

In the hydrogen-rich fuel gas obtained in Comparative Example 4, a hydrogen content was 505 mL/g, a methane content was 45 mL/g, a carbon dioxide content was 130 mL/g, a carbon monoxide content was 205 mL/g, and a tar yield was 0.8%.

In the hydrogen-enriched fuel gas obtained in Comparative Example 4, a hydrogen content was 665 mL/g, a methane content was 22 mL/g, a carbon dioxide content was 125 mL/g, a carbon monoxide content was 280 mL/g.

### Comparative Example 5

Comparative Example 5 differed from Example 1 in that a temperature for roasting the biomass waste in Comparative Example 5 was 150° C.

In the high temperature pyrolysis gas obtained in Comparative Example 5, a hydrogen content was 420 mL/g, a methane content was 75 mL/g, a carbon dioxide content was 110 mL/g, and a carbon monoxide content was 180 mL/g.

In the hydrogen-rich fuel gas obtained in Comparative Example 5, a hydrogen content was 520 mL/g, a methane content was 55 mL/g, a carbon dioxide content was 135 mL/g, a carbon monoxide content was 200 mL/g, and a tar yield was 0.2%.

In the hydrogen-enriched fuel gas obtained in Comparative Example 5, a hydrogen content was 679 mL/g, a methane content was 20 mL/g, a carbon dioxide content as 95 mL/g, and a carbon monoxide content was 260 mL/g.

### Comparative Example 6

Comparative Example 6 differed from Example 1 in that a catalyst loaded in the first atmospheric catalytic converter of Comparative Example 6 was a nickel-based catalyst using a mixture of the HZSM-5 molecular sieve and the aluminum smelting waste residue as a support. The process for preparing the nickel-based catalyst included the following steps.

(1) The aluminum smelting waste residue was soaked in dilute sulfuric acid with a mass concentration of 30% and stirred to react for 4 h to perform acidification pretreatment.

(2) The aluminum smelting waste residue after the acidification pretreatment was calcined in air at 600° C. for 3 h to obtain porous aluminum smelting waste residue.

(3) The porous aluminum smelting waste residue and the HZSM-5 molecular sieve were uniformly mixed at a mass ratio of 4:6 to obtain a composite support.

(4) The composite support was added to deionized water to obtain an aqueous solution. A mass ratio of the composite support to the deionized water was 1:10. Nickel nitrate was then added to the aqueous solution and subjected to ultrasonic treatment and stirred at 60° C. until water was completely evaporated to obtain a solid mixture. The solid mixture was then calcined in air at 550° C. for 2 h to obtain the nickel-based catalyst. A mass ratio of the nickel nitrate to the composite support was 12:100.

In the high temperature pyrolysis gas obtained in Comparative Example 6, a hydrogen content was 450 mL/g, a methane content was 55 mL/g, a carbon dioxide content was 100 mL/g, and a carbon monoxide content was 175 mL/g.

In the hydrogen-rich fuel gas obtained in Comparative Example 6, a hydrogen content was 493 mL/g, a methane content was 41 mL/g, a carbon dioxide content was 120 mL/g, a carbon monoxide content was 213 mL/g, and a tar yield was 1%.

In the hydrogen-enriched fuel gas obtained in Comparative Example 6, a hydrogen content was 690 mL/g, a methane content was 18 mL/g, a carbon dioxide content was 85 mL/g, and a carbon monoxide content was 253 mL/g.

### Comparative Example 7

Comparative Example 7 differed from Example 1 in that a catalyst loaded in the first atmospheric catalytic converter of Comparative Example 7 was an iron-based catalyst using the mixture of the HZSM-5 molecular sieve and the aluminum smelting waste residue as a support. The process for preparing the iron-based catalyst included the following steps.

(1) The aluminum smelting waste residue was soaked in dilute sulfuric acid with a mass concentration of 30% and stirred to react for 4 h to perform acidification pretreatment.

(2) The aluminum smelting waste residue after the acidification pretreatment was calcined in air at 600° C. for 3 h to obtain porous aluminum smelting waste residue.

(3) The porous aluminum smelting waste residue and the HZSM-5 molecular sieve were uniformly mixed at a mass ratio of 4:6 to obtain a composite support.

(4) The composite support was added to deionized water to obtain an aqueous solution. A mass ratio of the composite support to the deionized water was 1:10. Ferric chloride was then added to the aqueous solution and subjected to ultrasonic treatment and stirred at 60° C. until water was completely evaporated to obtain a solid mixture. The solid mixture was then calcined in air at 550° C. for 2 h to obtain the iron-based catalyst. A mass ratio of the ferric chloride to the composite support was 12:100.

In the high temperature pyrolysis gas obtained in Comparative Example 7, a hydrogen content was 450 mL/g, a methane content was 55 mL/g, a carbon dioxide content was 100 mL/g, and a carbon monoxide content was 175 mL/g.

In the hydrogen-rich fuel gas obtained in Comparative Example 7, a hydrogen content was 460 mL/g, a methane content was 56 mL/g, a carbon dioxide content was 160 mL/g, a carbon monoxide content was 166 mL/g, and a tar yield was 2%.

In the hydrogen-enriched fuel gas obtained in Comparative Example 7, a hydrogen content was 623 mL/g, a methane content was 28 mL/g, a carbon dioxide content was 105 mL/g, and a carbon monoxide content was 215 mL/g.

### Comparative Example 8

Comparative Example 8 differed from Example 1 in that the second atmospheric catalytic converter was omitted, and the hydrogen-rich fuel gas obtained from the first atmospheric catalytic converter was directly collected.

In the high temperature pyrolysis gas obtained in Comparative Example 8, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Comparative Example 8, a hydrogen content was 579 mL/g, a methane content was 33 mL/g, a carbon dioxide content was 125 mL/g, a carbon monoxide content was 223 mL/g, and a tar yield was reduced to 0.1%.

### Comparative Example 9

Comparative Example 9 differed from Example 1 in that the second atmospheric catalytic converter device was omitted, the nickel-based catalyst using the carbon molecular sieve as the support in the second atmospheric catalytic converter and the nickel-iron based catalyst using the mixture of the HZSM-5 molecular sieve and the aluminum smelting waste residue as the support in the first atmospheric catalytic converter were mixed at a mass ratio of 1:1, and the obtained fuel gas was collected.

In the high temperature pyrolysis gas obtained in Comparative Example 9, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Comparative Example 9, a hydrogen content was 675 mL/g, a methane content was 31 mL/g, a carbon dioxide content was 93 mL/g, a carbon monoxide content was 278 mL/g, and a tar yield was reduced to 0.05%.

### Comparative Example 10

Comparative Example 10 differed from Example 1 in that the catalyst loaded in the second atmospheric catalytic converter was a nickel-based catalyst using the HZSM-5 molecular sieve as a support in Comparative Example 10. The process for preparing the nickel-based catalyst included the following steps.

The HZSM-5 molecular sieve was added to deionized water to obtain an aqueous solution. A mass ratio of the HZSM-5 molecular sieve to the deionized water was 1:10. Nickel nitrate was then added to the aqueous solution and subjected to ultrasonic treatment and stirred at 60° C. until water was completely evaporated to obtain a solid mixture. The solid mixture was then calcined in air at 550° C. for 2 h to obtain the nickel-based catalyst using the HZSM-5 molecular sieve as the support. A mass ratio of the nickel nitrate to the HZSM-5 molecular sieve was 8:100.

In the high temperature pyrolysis gas obtained in Comparative Example 10, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Comparative Example 10, a hydrogen content was 579 mL/g, a methane content was 33 mL/g, a carbon dioxide content was 125 mL/g, a carbon monoxide content was 223 mL/g, and a tar yield was reduced to 0.1%.

In the hydrogen-enriched fuel gas obtained in Comparative Example 10, a hydrogen content was 689 mL/g, a methane content was 23 mL/g, a carbon dioxide content was 65 mL/g, and a carbon monoxide content was 273 mL/g.

### Comparative Example 11

Comparative Example 11 differed from Example 1 in that a catalyst loaded in the second atmospheric catalytic converter was a nickel-based catalyst using commercially available activated carbon (with an iodine adsorption value of 800 mg/g) as a support, and a process for preparing the nickel-based catalyst included the following steps.

The activated carbon was added to deionized water to obtain an aqueous solution. A mass ratio of the activated carbon to the deionized water was 1:10. Nickel nitrate was then added to the aqueous solution and subjected to ultrasonic treatment and stirred at 60° C. until water was completely evaporated to obtain a solid mixture. The solid mixture was then calcined in nitrogen atmosphere at 550° C. for 2 h to obtain the nickel-based catalyst using the activated carbon as the support. A mass ratio of the nickel nitrate to the activated carbon was 8:100.

In the high temperature pyrolysis gas obtained in Comparative Example 11, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Comparative Example 11, a hydrogen content was 579 mL/g, a methane content was 33 mL/g, a carbon dioxide content was 125 mL/g, a carbon monoxide content was 223 mL/g, and a tar yield was reduced to 0.1%.

In the hydrogen-enriched fuel gas obtained in Comparative Example 11, a hydrogen content was 703 mL/g, a methane content was 26 mL/g, a carbon dioxide content was 55 mL/g, and a carbon monoxide content was 295 mL/g.

### Comparative Example 12

Comparative Example 12 differed from Example 1 in that a catalyst loaded in the second atmospheric catalytic converter was a nickel-based catalyst using γ-alumina as a support, and a process for preparing the nickel-based catalyst included the following steps.

γ-alumina was added to deionized water to obtain an aqueous solution. A mass ratio of the γ-alumina to the deionized water was 1:10. Nickel nitrate was then added to the aqueous solution and subjected to ultrasonic treatment and stirred at 60° C. until water was completely evaporated to obtain a solid mixture. The solid mixture was then calcined in air at 550° C. for 2 h to obtain the nickel-based catalyst using the γ-alumina as the support. A mass ratio of the nickel nitrate to the alumina was 8:100.

In the high temperature pyrolysis gas obtained in Comparative Example 12, a hydrogen content was 450 mL/g, a methane content was 55 mL/g, a carbon dioxide content was 100 mL/g, a carbon monoxide content was 175 mL/g, and a tar yield was 8%.

In the hydrogen-rich fuel gas obtained in Comparative Example 12, a hydrogen content was 579 mL/g, a methane content was 33 mL/g, a carbon dioxide content was 125 mL/g, a carbon monoxide content was 223 mL/g, and a tar yield was reduced to 0.1%.

In the hydrogen-enriched fuel gas obtained in Comparative Example 12, a hydrogen content was 693 mL/g, a methane content was 24 mL/g, a carbon dioxide content was 75 mL/g, and a carbon monoxide content was 255 mL/g.

Based on the exemplary embodiments of the present disclosure as inspiration, through the above description, relevant personnel may make various changes and modifications without departing from the scope of the technical concept of the present disclosure. The technical scope of the present disclosure is not limited to the content of the description, and the technical scope must be determined based on the scope of the claims.

What is claimed is:

1. A staged pyrolysis-catalytic gasification process system for hydrogen production from biomass waste, comprising:
(1) drying the biomass waste, and crushing the biomass waste to obtain crushed biomass waste with a particle size of not greater than 3 mm;
(2) continuously adding the crushed biomass waste obtained in step (1) as feed material into a cascading pyrolysis device, processing the feed material through a roasting section, a thermal premixing section, a pyrolysis gasification section, and a catalytic reforming section sequentially under an action of gravity to obtain semi-coke and volatile matter, periodically discharging the semi-coke from a bottom of the cascading pyrolysis device, and filtering the volatile matter through the semi-coke accumulated in a catalytic conversion section to remove fly ash to obtain high temperature pyrolysis gas;
(3) continuously introducing the high temperature pyrolysis gas into a first atmospheric catalytic converter, to cause that tar in the high temperature pyrolysis gas undergoes catalytic cracking to obtain hydrogen-rich fuel gas; and
(4) continuously introducing the hydrogen-rich fuel gas obtained in the first atmospheric catalytic converter into a second atmospheric catalytic converter, to cause that alkane gas in the hydrogen-rich fuel gas undergoes catalytic cracking to produce hydrogen, and hydrogen-enriched fuel gas is produced at a bottom of the second atmospheric catalytic converter.

2. The staged pyrolysis-catalytic gasification process system for hydrogen production from biomass waste according to claim 1, wherein the crushed biomass waste obtained in step (1) is added into the cascading pyrolysis device through a screw feeder, and a feeding rate is within a range of 0.5 kg/h to 5 kg/h.

3. The staged pyrolysis-catalytic gasification process system for hydrogen production from biomass waste according to claim 1, wherein temperature ranges of the roasting section, the thermal premixing section, the pyrolysis gasification section, and the catalytic reforming section in step (2) are 250° C. to 300° C., 500° C. to 600° C., 750° C. to 800° C., and 900° C. to 1000° C., respectively.

4. The staged pyrolysis-catalytic gasification process system for hydrogen production from biomass waste according to claim 1, wherein a mixed gas of pure oxygen and steam is continuously introduced into the catalytic reforming section;
a gas inlet of the catalytic reforming section is located at a middle part of the catalytic reforming section;
a gas inlet direction of the mixed gas is parallel to ground;
a flow rate of the pure oxygen is within a range of 100 mL/min to 200 mL/min; and
a flow rate of the steam is within a range of 0.5 g/min to 2 g/min.

5. The staged pyrolysis-catalytic gasification process system for hydrogen production from biomass waste according to claim 1, wherein
semi-coke discharge is started when a height of the semi-coke in the cascading pyrolysis device exceeds an edge position below a gas inlet of the catalytic reforming section; and
the semi-coke discharge is stopped when the height of the semi-coke in the cascading pyrolysis device is below a middle position of the catalytic reforming section.

6. The staged pyrolysis-catalytic gasification process system for hydrogen production from biomass waste according to claim 1, wherein
a catalyst loaded in the first atmospheric catalytic converter is a nickel-iron based catalyst using a mixture of Hydrogen Zeolite Socony Mobil-5 (HZSM-5) molecular sieve and aluminum smelting waste residue as a support.

7. The staged pyrolysis-catalytic gasification process system for hydrogen production from biomass waste according to claim 6, wherein the nickel-iron based catalyst is prepared by a process including:
(1) subjecting the aluminum smelting waste residue to acidification pretreatment and high-temperature calcination to obtain porous aluminum smelting waste residue;
(2) uniformly mixing the porous aluminum smelting waste residue and the HZSM-5 molecular sieve at a mass ratio of (0-7):(3-10) to obtain a composite support; and
(3) adding the composite support to deionized water to obtain an aqueous solution, wherein a mass ratio of the composite support to the deionized water is (1-10):100; then adding nickel nitrate and ferric chloride to the aqueous solution, performing ultrasonic treatment and stirring at 60° C. to 80° C. until water is completely evaporated to obtain a solid mixture; and then placing the solid mixture at 500° C. to 600° C. and calcining in air for 1.5 h to 2 h to obtain the nickel-iron based catalyst, wherein a mass ratio of the nickel nitrate, the ferric chloride, and the composite support is 8:4:100.

8. The staged pyrolysis-catalytic gasification process system for hydrogen production from biomass waste according to claim 1, wherein a packed bulk density of a catalyst in the first atmospheric catalytic conversion reactor is within a range of 0.8 g/cm³ to 1.2 g/cm³.

9. The staged pyrolysis-catalytic gasification process system for hydrogen production from biomass waste according to claim 1, wherein a catalyst loaded in the second atmospheric catalytic converter is a nickel-based catalyst using a carbon molecular sieve as a support.

10. The staged pyrolysis-catalytic gasification process system for hydrogen production from biomass waste according to claim 9, wherein the nickel-based catalyst is prepared by a process including:
(1) uniformly mixing biochar and KOH at a mass ratio of 1:(0.5-4), performing chemical activation at 500° C. to 600° C. for 1 h to 2 h under nitrogen protection, then heating to 800° C. to 1000° C., and performing physical activation for 2 h to 4 h by introducing CO₂ while maintaining introduction of the nitrogen to obtain activated carbon;
(2) introducing toluene vapor into the activated carbon at a flow rate of 0.2 g/min to 1.5 g/min through a benzene deposition manner, and reacting at 600° C. to 900° C. for 0.5 h to 1.5 h to perform pore-filling carbonization and deposition on macropores of the activated carbon, to form a hierarchical pore carbon molecular sieve; and
(3) adding the hierarchical porous carbon molecular sieve into deionized water, wherein a mass ratio of the hierarchical porous carbon molecular sieve to the deionized water is (1-2): 10; then adding nickel nitrate, performing ultrasonic treatment and stirring at 60° C. to 80° C. until water is completely evaporated; then calcining at 500° C. to 600° C. for 1.5 h to 2.0 h under protection of nitrogen or inert gas to obtain the nickel-based catalyst.
